(19) United States
(12) Patent Application Publication
(10) Pub. No.: US 2005/0057582 A1
(43) Pub. Date: Mar. 17, 2005

(54) Image signal processor circuit and portable terminal device

(76) Inventor: Masayuki Naito, Sano-shi (JP)

Correspondence Address: Jonathan P. Osha;Osha & May L.L.P., Suite 2800, 1221 McKinney St., Houston, TX, 77010, US

(21) Appl. No.: 10/929,945

(22) Filed: Aug. 30, 2004

(30) Foreign Application Priority Data
Aug. 29, 2003 (JP) 2003-306719

(51) Int. Cl. G09G 5/10

(52) U.S. Cl. 345/690

(57) ABSTRACT

An on-screen display for displaying a character or the like on a television image. On a portable phone, a television image signal is received at a television antenna and a television image is displayed on an LCD panel. An OSD processor unit of an LSI processor chip has two color tables, each outputting 16 colors. By specifying a color of a character displayed on the television screen and selecting one of two color tables, a total of 32 colors are displayed.

### CROSS-REFERENCE TO RELATED APPLICATIONS

The priority Japanese Patent Application Number 2003-306719 upon which this patent application is based is hereby incorporated by reference.

### BACKGROUND OF THE INVENTION

1. Field of the Invention

The present invention relates to an image signal processor circuit and a portable terminal device, and in particular, to control of color when a character, a pattern, or the like is displayed on a screen.

2. Description of the Related Art

In recent years, a function for displaying a television image has been added to a portable terminal device such as a portable phone and a technique for displaying a character, a pattern, or the like on a television screen which is commonly called an on-screen display (OSD) has been developed.

When a character is to be displayed on a liquid crystal panel (LCD panel) having a resolution of QVGA (480×234), for example, one character is formed with 12 dots×18 dots and characters are displayed 40 characters per line and 13 lines per screen. A color of the character is set using a VRAM and a color table. For example, the color of the character is specified from among 16 colors using 4-bit data from a VRAM. The 4-bit data is data for specifying an address in a color table. Signal data values for an R signal, a G signal, and a B signal are written and set to each address in the color table in advance. For example, an address of “0000” may correspond to an R signal of XXX, a G signal of YYY, and a B signal of ZZZ, etc. When the R signal, G signal, and B signal are each represented with 3-bit data, 8 levels of R signal, 8 levels of G signal, and 8 levels of B signal can be realized, resulting in a total of 512 colors. The color table assigns these color data in each of 16 addresses represented by 4-bit data and outputs 16 colors from among the 512 colors.

FIG. 7 is a diagram showing a conceptual structure of a color creator circuit using a color table. A 4-bit signal (4-bit data) from a VRAM 50 for color specification is supplied as address data of a color table 52. The color table 52 comprises flip-flops (FF) or the like and defines values for the R signal, G signal, and B signal in each of 16 addresses from 0000-1111. An R signal, a G signal, and a B signal corresponding to the address specified by the 4-bit signal are output and the color of a character to be displayed is determined from among 16 colors.

Japanese Patent Laid-Open Publication No. 2003-111004 discloses a portable phone which can receive a television image signal and which allows for viewing of a television image.

However, variations of demands of users who use a portable terminal device such as a portable phone have increased, and in particular, there is a large demand for customizing, by the user, the screen display so that the color of the character or the pattern or a background color which becomes the background of the character or the pattern becomes more colorful or these colors are set to unique colors. With 16 colors, however, there is a limitation in satisfying varying user demands.

For this purpose, in the structure of FIG. 7, it is possible to specify an address in the color table with a 5-bit signal (5-bit data) from the color specification VRAM 50 to expand the setting of R signal, G signal, and B signal to 32 addresses of 00000-11111 in the color table 52 and to consequently increase the number of possible colors to 32, but such an expansion will complicate the structure.

### SUMMARY OF THE INVENTION

The present invention advantageously provides an image signal processor circuit and a portable terminal device in which a number of colors in an image can be increased with a simple structure.

According to one aspect of the present invention, there is provided an image signal processor circuit comprising a color specifying unit for specifying a color of an image using an n-bit signal; m color table units (m is a natural number greater than or equal to 2) each for outputting 2ⁿ colors by outputting each of an R signal, a G signal, and a B signal according to an n-bit signal output from the color specifying unit; and a selector unit for selecting one of the m color table units. In the present invention, a plurality of color table units are provided and 2ⁿ×m colors are output with a specification using n bits by selecting from among the plurality of color table units.

According to another aspect of the present invention, it is preferable that, in the image signal processor circuit, the image is a character, the color specifying unit specifies, using the n-bit signal, a color in each of a character portion and a portion other than a character in a character display region of a predetermined size, the color table unit outputs a color in each of the character portion and the portion other than the character according to the n-bit signal, and the selector unit selects one of the m color table units for each of the character display regions of predetermined size.

According to another aspect of the present invention, it is preferable that, in the image signal processor circuit, the image is a pattern, the color specifying unit specifies a color of the pattern using the n-bit signal, the color table unit outputs a color of the pattern according to the n-bit signal, and the selector unit selects one of the m color table units for each of pattern display regions of a predetermined size.

According to another aspect of the present invention, it is preferable that, in the image signal processor circuit, the image is a background image, the color specifying unit specifies a color of the background image using the n-bit signal, and the color table unit outputs a color of the background image according to the n-bit signal.

According to yet another aspect of the present invention, it is preferable that, in the image signal processor circuit, the image is a character or a pattern displayed overlapping a television image, the color specifying unit specifies a color of the character or pattern with the n-bit signal, and the color table unit outputs a color of the character or pattern according to the n-bit signal.

According to another aspect of the present invention, there is provided a portable terminal device comprising a television antenna unit, a television image signal processor unit for processing a television image signal from the television antenna unit, a display unit for displaying a television image according to a signal from the television image signal processor unit, and an image processor unit for displaying a character or a pattern overlapping the television image, wherein the image processor unit comprises a color specifying unit for specifying a color of the character, pattern, or a background thereof using an n-bit signal, m color table units (m is a natural number greater than or equal to 2) each for outputting 2ⁿ colors by outputting each of an R signal, a G signal, and a B signal according to an n-bit signal output from the color specifying unit, and a selector unit for selecting one of the m color table units.

The present invention may be more clearly understood by referring to the preferred embodiments described below. The scope of the present invention, however, is not limited to these preferred embodiments.

### BRIEF DESCRIPTION OF THE DRAWINGS

Preferred embodiments of the present invention will be described in detail based on the following figures, wherein:

FIG. 1 is a diagram showing an overall structure of a portable phone;

FIG. 2 is a block diagram showing a structure of an OSD (on-screen display) processor unit;

FIG. 3 is a block diagram showing a structure of an output controller unit;

FIG. 4 is an explanatory diagram of a color table;

FIG. 5 is an explanatory diagram of a structure of a multi-layer structure;

FIG. 6 is an explanatory diagram of a main screen; and

FIG. 7 is a diagram showing a structure of a color creator unit according to a related art.

### DESCRIPTION OF PREFERRED EMBODIMENT

A preferred embodiment of the present invention will now be described referring to the drawings and exemplifying a portable phone.

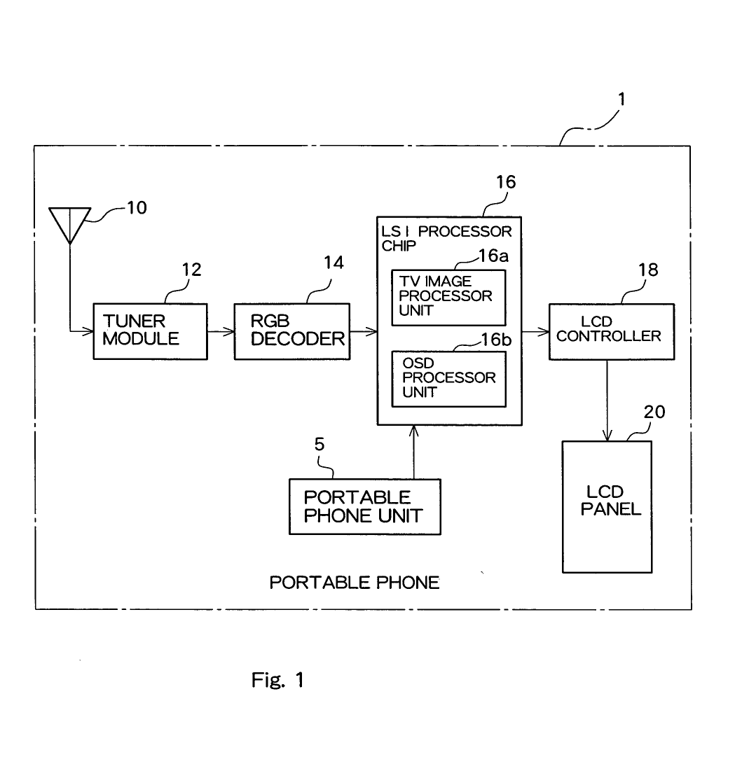

FIG. 1 shows an overall structure of a portable phone which can display a television image. The portable phone 1 comprises a portable phone unit 5, a television antenna 10, a tuner module 12 for receiving a television image signal, an RGB decoder 14 for separating and extracting an R signal, a G signal, and a B signal from the television image signal received at the tuner module 12, an LSI processor chip 16, a liquid crystal panel (LCD panel) 20 which functions as a display, and an LCD controller (LCD driver) 18 for supplying a television image signal to the LCD panel 20. The LSI processor chip 16 comprises a television image processor unit 16a for converting the R, G, and B signals into digital signals using an analog-to-digital converter, applying various processes to the digital signals, and storing the digital signals in a memory and an OSD processor unit 16b for displaying a character or a pattern on a television screen. The LCD panel 20 has a resolution of, for example, QVGA (480×234).

One RAM or two RAMs are provided on the television image processor unit 16a of the LSI processor chip 16 and function as field memories for storing each field data which is a part of the television image signal data. Television image signal data which is stored in the RAM of the television image processor unit 16a and read is temporarily stored in a RAM of the LCD controller 18, and is then read and supplied to the LCD panel 20.

On the other hand, a VRAM, an FROM, and an output controller circuit having a color table for outputting a color signal are provided on the OSD processor unit 16b of the LSI processor chip 16. The color signal from the output controller circuit is supplied to the LCD controller 18 and further to the LCD panel 20. When a character or a pattern is to be displayed overlapping a television screen, signals are synthesized in the LCD controller 18 and supplied to the LCD panel 20.

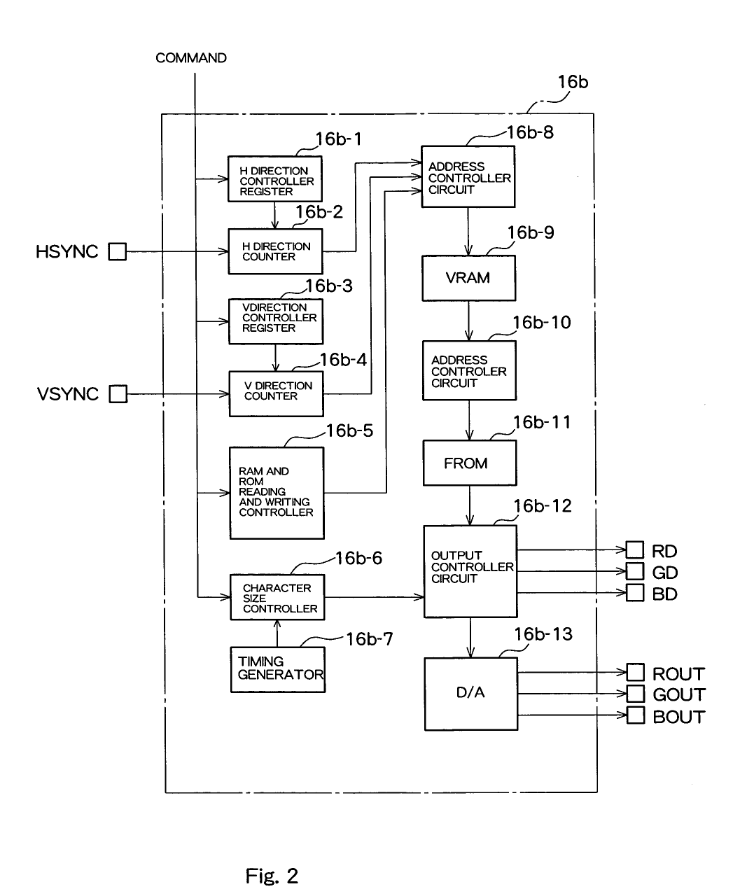

FIG. 2 is a block diagram showing a structure of the OSD processor unit 16b. An H (horizontal) direction counter 16b-2 and a V (vertical) direction counter 16b-4 are provided and HSYNC (horizontal synchronization signal) and VSYNC (vertical synchronization signal) are respectively input to these counters. The H direction counter 16b-2 counts HSYNC and the V direction counter 16b-4 counts VSYNC to detect a horizontal position and a vertical position. The horizontal and vertical positions are respectively controlled by an H direction controller register 16b-1 and a V direction controller register 16b-3, and the H direction controller register 16b-1 and the V direction controller register 16b-3 control respective counters, through an input of a command, such that desired horizontal and vertical positions are realized. Horizontal position data from the H direction counter 16b-2 and vertical position data from the V direction counter 16b-4 are supplied to an address controller circuit 16b-8. A RAM and ROM reading and writing controller circuit 16b-5, on the other hand, controls a reading operation from and a writing operation to RAM and ROM based on an input command.

A VRAM 16b-9 is for storing data for specifying a color of a character or a pattern, and data of specified color is written to the VRAM 16b-9 based on an input command. The input command has, for example, a 2-byte structure, with the upper byte defining a type of control and the lower byte defining the data content. A color of the character is specified with 4 bits within 8 bits forming the lower byte. When data is written to the VRAM 16b-9, 4-bit data of “0000”-“1111” is written to an address set in the address controller circuit 16b-8. The 4-bit data (a character color specifying signal) read from the VRAM 16b-9 is supplied to an output controller circuit 16b-12.

An FROM 16b-11 stores a form of a character or a pattern which is commonly called a character code, and stores, for example, 512 characters and patterns. In order to display a desired character or pattern, the character code is specified with the lower byte of the command. The read data is supplied to the output controller circuit 16b-12. It is also possible to further provide a ROM externally in addition to the FROM 16b-11 to allow display of a greater number of types of characters or patterns.

A character size controller circuit 16b-6 supplies, to the output controller circuit 16b-12, a size control signal to adjust the character size to a character size specified in the input command using a timing signal from a timing generator 16b-7.

The output controller circuit 16b-12 comprises a plurality of color tables (in the embodiment, two color tables) and creates a color of a character or a pattern specified by the FROM 16b-11, that is, an R signal, a G signal, and a B signal, using the color tables. The R signal, G signal, and B signal are created for each dot of the LCD panel 20. The R signal, G signal, and B signal from the output controller circuit 16b-12 are suitably converted by a digital-to-analog converter D/A 16b-13 into analog signals and are output. In FIG. 2, RD, GD, and BD represent a digital R signal, a digital G signal, and a digital B signal, and ROUT, GOUT, and BOUT represent an analog R signal, an analog G signal, and an analog B signal.

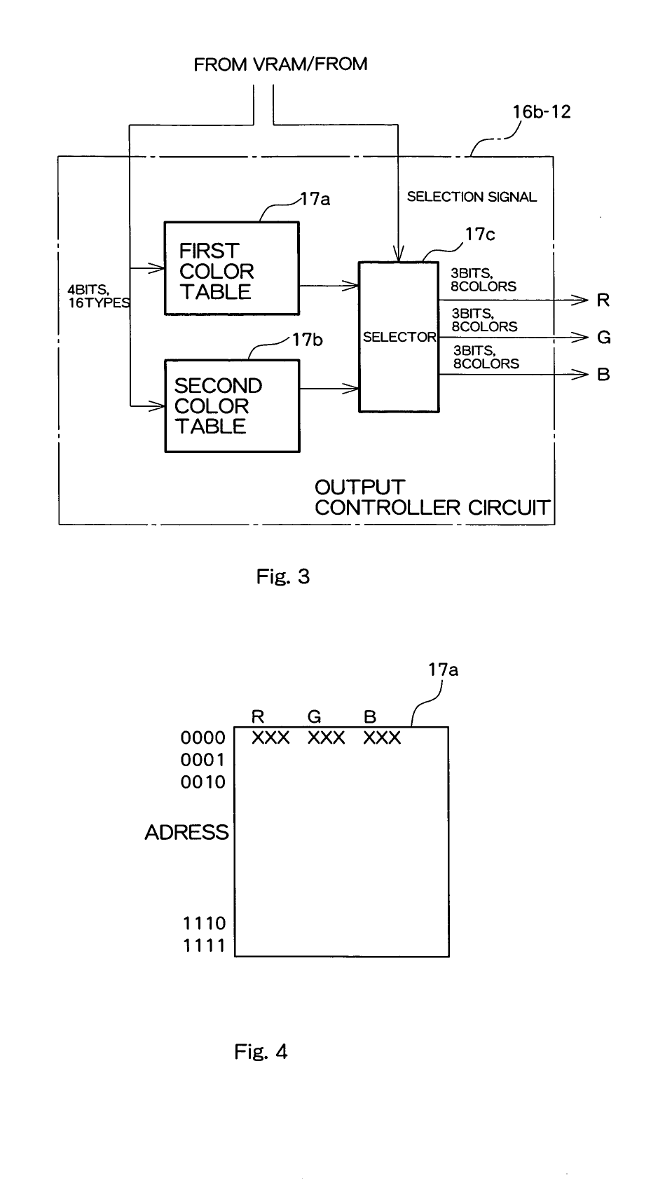

FIG. 3 is a block diagram showing a structure of the output controller circuit 16b-12 in FIG. 2. The output controller circuit 16b-12 comprises two color tables 17a and 17b (in FIG. 3, these color tables are shown as a first color table and a second color table) and a selector 17c. Each of the color tables 17a and 17b is a table for defining an R signal, a G signal, and a B signal in each of 16 addresses of “0000” to “1111”. The color tables 17a and 17b define different sets of 16 colors, resulting in a total of 32 colors defined by the color tables 17a and 17b. FIG. 4 schematically shows the color table 17a. Corresponding to a 4-bit address of “0000”, an R signal of “XXX”, a G signal of “XXX”, and a B signal of “XXX” are defined with 3 bits. It is also possible to set one of the 16 colors as a transparent color. The color table 17b has a similar structure with color data defined in each of 16 addresses. The 16 colors defined in the color table 17a and the 16 colors defined in the color table 17b may be separated from a viewpoint of a color phase or from a viewpoint of luminosity. For example, the color table 17a may define colors with low luminosity (dark colors) while the color table 17b may define colors with high luminosity (bright colors). Specific structures of the color tables 17a and 17b are realized with flip-flops (FFs). 4-bit data from the VRAM 16b-9 is supplied to the color tables 17a and 17b. Each of the color tables 17a and 17b outputs an R signal, a G signal, and a B signal corresponding to the address specified by the 4-bit data to the selector 17c.

The selector 17c receives an input of a selection signal supplied from the VRAM 16b-9 and selects and outputs one of the outputs of the color tables 17a and 17b according to the selection signal. The selection signal is specified by one bit within a lower byte of the input command, stored in the VRAM 16b-9, and supplied to the output controller circuit 16b-12. The selection signal is defined, for example, such that the color table 17a is selected when the selection signal is “0” and the color table 17b is selected when the selection signal is “1”.

The OSD processor unit 16b has a structure as described above. In the following description, an example configuration is shown for a case in which a character is to be displayed in “blue” at a predetermined position on the LCD panel 20 which is displaying a television screen and the color specifying data corresponding to blue is “0001”.

A horizontal position and a vertical position in which the character is to be displayed are determined by the H direction controller register 16b-1, H direction counter 16b-2, V direction controller register 16b-3, and V direction counter 16b-4 and data of “00001” is written to the VRAM 16b-9 in response to an input command. The “0” in the number-four bit of “00001” is a bit specifying the color table 17a and 4 bits in “00001” from the LSB (least significant bit) to the number-three bit, that is, “0001”, are bits for specifying a color (in this configuration, blue). The written data of “0001”, that is, the 4-bit color specifying signal is read from the VRAM 16b-9 and supplied to the color tables 17a and 17b of the output controller circuit 16b-12. The “0” in the number-four bit, that is, the selection signal, is supplied to the selector 17c of the output controller circuit 16b-12.

At the color table 17a to which data of “0001” from the VRAM 16b-9 is input, an R signal of “000”, a G signal of “000”, and a B signal of “111” which correspond to the data of “0001” are output to the selector 17c. Similarly, at the color table 17b to which data of “0001” from the VRAM 16b-9 is input, an R signal of “001”, a G signal of “001”, and a B signal of “001” which correspond to the data of “0001” are output to the selector 17c. The selector 17c selects the color table 17a according to the selection signal of “0” from the VRAM 16b-9 and outputs, to the LCD controller 18, the R signal of “000”, G signal of “000”, and B signal of “111” from the color table 17a. In each dot of 12 dots×18 dots forming a character, the selection of the selector 17c is fixed to the color table 17a regardless of the selection signal, and the color of the character displayed at the predetermined position becomes blue in this manner.

When a pattern is to be displayed in white at a predetermined position on the LCD panel 20 on which a television screen is displayed, a similar process can be employed. In the following description, an example configuration is described in which an address corresponding to white is “1111”.

A horizontal position and a vertical position in which a pattern is to be displayed are determined by the H direction controller register 16b-1, the H direction counter 16b-2, the V direction controller register 16b-3, and the V direction counter 16b-4 and data of “01111” is written to the VRAM 16b-9. The written data of “1111”, that is, the 4-bit color specifying signal is supplied to the color tables 17a and 17b of the output controller circuit 16b-12. The “0” of the number-four bit, that is, the selection signal, is supplied to the selector 17c of the output controller circuit 16b-12.

At the color table 17a to which data of “1111” from the VRAM 16b-9 is input, an R signal of “111”, a G signal of “111”, and a b signal of “111” which correspond to the data of “1111” are output to the selector 17c. Similarly, at the color table 17b to which the data of “1111” is input, an R signal of “001”, a G signal of “000”, and a B signal of “001” which correspond to the data of “1111” are output to the selector 17c. The selector 17c selects the color table 17a according to the selection signal of “0” from the VRAM 16b-9, selects the R signal of “111”, G signal of “111”, and B signal of “111” from the color table 17a, and outputs to the LCD controller 18. In each dot of the 12 dots×18 dots forming a pattern, the selection of the selector 17c is fixed to the color table 17a. In this manner, the pattern displayed on the predetermined position becomes white.

As described, the selection between color tables 17a and 17b by the selector 17c is executed for each unit of 12 dots×18 dots, which is the unit of display of a character or a pattern. By selecting the color table 17a to display a certain character and selecting the color table 17b to display another character, it is possible to display characters with a total of 32 colors. Similarly, by selecting the color table 17a to display a certain pattern and selecting the color table 17b to display another pattern, it is possible to display patterns with a total of 32 colors.

Because a 4-bit color specifying signal and a 1-bit selection signal are supplied from the VRAM 16b-9 to the output controller circuit 16b-12 in the embodiment, the number of bits is increased compared to when only a 4-bit color specifying signal is supplied. However, the selection signal need not be supplied to each of the dots (480×234) of the LCD panel 20, but only needs be supplied to each of a group of 12 dots×18 dots which is a unit of display of the character or pattern, that is, to each of 40 characters×lines=520 characters. In addition, the increase in the number of bits when the number of color tables is increased from 1 to 2 is 16 colors×(3 bits for R+3 bits for G+3 bits for B)=144 bits, and therefore, the increase in the number of bits can be maintained at a low level even with both configurations.

In the embodiment, a television screen is displayed on the LCD panel 20 and a character or a pattern is displayed overlapping the television screen, but the present invention is not limited to such a configuration and it is possible to realize various other displays.

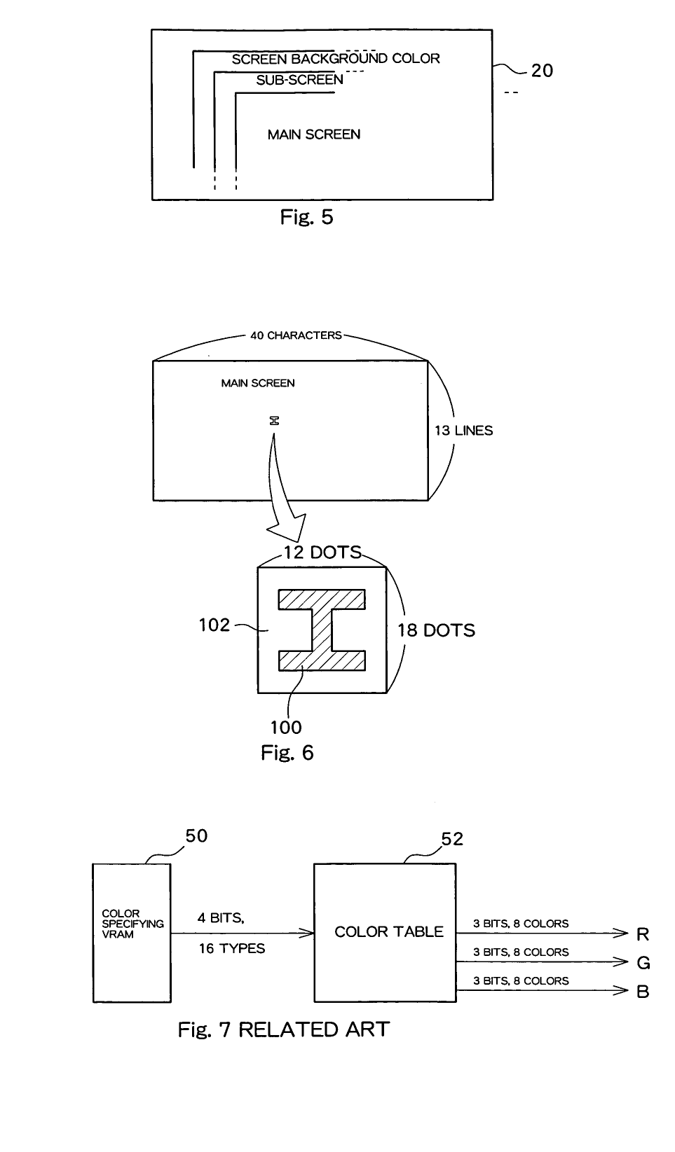

For example, as shown in FIG. 5, it is possible to employ a multi-layer structure for a screen displayed on the LCD panel 20 and to display a screen background color, a sub-screen, and a main screen overlapping each other. When a character or a pattern is to be displayed on the television screen, a television screen is displayed on the screen background color or sub-screen, the character or the pattern is displayed on the main screen, and the screens are overlapped. Alternatively, it is also possible to set the screen background color to one color of the 32 colors using the color tables 17a and 17b and to display a character or a pattern on the main screen.

When a character is to be displayed, it is possible to separate a unit of display of a character with a predetermined size into a character region and a region other than a character and to select a color of each region from among 16 colors using the color table 17a or the color table 17b.

FIG. 6 shows a main screen in which a character is displayed. As described, the main screen is made of 40 characters×13 lines and one character is displayed with a unit of 12 dots×18 dots. The unit region is separated into a region 100 in which a character is displayed and a region in which objects other than a character are displayed. It is possible to use the color table 17a for the character display region 100 to set one color from among 16 colors and to set another color of the color table 17a for the region 102 for other than characters. The color specification maybe realized by, for example, specifying the color of the character region with a total of 4 bits from an LSB to number-three bit of the lower byte of the input command and specifying the color of the region other than characters with a total of 4 bits from number-four bit to the number-seven bit. In this configuration, because 8 bits are used for specifying colors, the selection signal for selecting between the color tables 17a and 17b cannot be included. Alternatively, it is also possible to allow selection among different color tables in the character region 100 and the region 102 other than character by using the LSB or the like of the upper byte of the command as the bit for the selection signal.

In the embodiment, two color tables 17a and 17b are used to realize 32 colors, but it is also possible to assign separate functions or usages to the color tables 17a and 17b. For example, it is possible to use the color table 17a as dedicated to the character region 100 and the region 102 other than characters and to use the color table 17b as dedicated to the background color. By setting, in the color table 17b, colors with a color phase or luminosity that is more frequently used in the background color, it is possible to display colors which satisfy users' demands even with 16 colors. When a character is displayed overlapping a television screen, the region 102 for other than characters may be set to a transparent color.

In the embodiment, two color tables 17a and 17b are provided on the output controller circuit 16b-12. However, the present invention is not limited to such a configuration and three or more color tables may be provided as necessary. By setting all colors of 16 colors defined in one color table different from the 16 colors defined in each of the other color tables, it is possible to realize 16×m colors wherein m is the number of color tables.

The embodiment has been described exemplifying a portable phone, but the present invention is not limited to a portable phone and may be applied to any portable terminal device such as a PDA (personal digital assistant).

1. An image signal processor circuit for displaying an image on a display, the image signal processor circuit comprising:
a color specifying unit for specifying a color of the image using an n-bit signal;
m color table units each for outputting 2ⁿ colors by outputting each of an R signal, a G signal, and a B signal according to an n-bit signal output from the color specifying unit, wherein m is a natural number greater than or equal to 2; and
a selector unit for selecting one of the m color table units, wherein
2ⁿ×m colors are output with a specification using the n-bit signal.

2. An image signal processor circuit according to claim 1, wherein
the image is a character;
the color specifying unit specifies, using the n-bit signal, a color in each of a character portion and a portion other than characters in a character display region of a predetermined size;
the color table unit outputs a color in each of the character portion and the portion other than characters according to the n-bit signal; and
the selector unit selects one of the m color table units for each of the character display regions of the predetermined size.

3. An image signal processor circuit according to claim 1, wherein
the image is a pattern;
the color specifying unit specifies a color of the pattern using the n-bit signal;
the color table unit outputs a color of the pattern according to the n-bit signal; and
the selector unit selects one of the m color table units for each of pattern display regions of a predetermined size.

4. An image signal processor circuit according to claim 1, wherein
the image is a background image;
the color specifying unit specifies a color of the background image using the n-bit signal; and
the color table unit outputs a color of the background image according to the n-bit signal.

5. An image signal processor circuit according to claim 1, wherein
the image is a character or a pattern displayed overlapping a television image;
the color specifying unit specifies a color of the character or pattern using the n-bit signal; and
the color table unit outputs a color of the character or pattern according to the n-bit signal.

6. An image signal processor circuit according to claim 1, wherein
the n bits are 4 bits, and 16×m colors are output by each of the color table units outputting 16 colors according to the 4-bit signal.

7. A portable terminal device comprising:
a television antenna unit;
a television image signal processor unit for processing a television image signal from the television antenna unit;
a display unit for displaying a television image according to a signal from the television image signal processor unit; and
an image processor unit for displaying a character or a pattern overlapping the television image, wherein
the image processor unit comprises:
a color specifying unit for specifying a color of the character, pattern, or a background using an n-bit signal;
m color table units each for outputting 2ⁿ colors by outputting each of an R signal, a G signal, and a B signal according to an n-bit signal output from the color specifying unit, wherein m is a natural number greater than or equal to 2; and
a selector unit for selecting one of the m color table units.
